(19) United States
(12) Patent Application Publication
(10) Pub. No.: US 2013/0166257 A1
(43) Pub. Date: Jun. 27, 2013

(54) METHOD FOR MODELLING THE INTERACTIONS OF AN IMPULSIVE WAVE WITH A MEDIUM

(71) Applicants: Dominique Placko, Creteil (FR); Pierre-Yves Joubert, Sceaux (FR); Thierry Bore, Paris (FR)

(72) Inventors: Dominique Placko, Creteil (FR); Pierre-Yves Joubert, Sceaux (FR); Thierry Bore, Paris (FR)

(21) Appl. No.: 13/575,139

(22) PCT Filed: Jan. 26, 2011
(86) PCT No.: PCT/EP2011/051077

§ 371 Date: Oct. 26, 2012

Related U.S. Application Data
(60) Provisional application No. 61/298,496, filed on Jan. 26, 2010.

(51) Int. Cl. G06F 17/50

(52) U.S. Cl. CPC G06F 17/5009
USPC 703/2

(57) ABSTRACT

The invention relates to a method for modelling the interactions of a wave, generated by a source emitting an impulsive signal of arbitrary shape, with a medium, including steps involving: a) elaboration of a generic model by the method called “DPSM”; b) Fourier series decomposition of the impulsive signal c) For each of the harmonics arising from the foregoing decomposition, calculation of a model specifically for the harmonic in question from the generic model previously elaborated; and d) superposition of a set of specific models thus calculated in order to assemble a final model.

The invention relates to a method for modelling the three-dimensional interactions of a wave, generated by an impulsive source of arbitrary shape, with a medium.

### TECHNOLOGICAL BACKGROUND

The study of complex media (e.g. nonlinear, diffusive, stratified, with volume inclusions, etc. . . . ) by impulsive systems makes it possible to enrich the observation of these media, and hence to facilitate their analysis.

To obtain a model of a problem in which static or dynamic quantities (electrostatic, electromagnetic, ultrasonic, etc. . . . ) are involved, a partial differential equation (Poisson, d'Alembert, Helmholtz) must generally be established based on local equations (Maxwell's for instance). Their solution, aside from “academic” cases, quickly becomes complicated when boundary conditions are considered: multiple electrodes, media with complicated geometries including interfaces delimiting objects with different physical properties.

To grasp the problem as a whole, the user generally turns to finite-element solutions, or techniques such as boundary integral methods, BEM (boundary element methods), or methods of singularities (Bousquet, 1990) which make it possible to remain closer to the initial physical problem. The purpose of modelling is generally multifold: it is not just a matter of understanding, but also of optimizing the modelled system (a sensor for example) and having available a model usable in “quasi-real” time in an inversion or data- or signal-processing algorithm.

Although impulsive, hence broadband, observation is known in itself to produce data that are enriched by comparison with harmonic techniques, it is also more difficult to interpret. For example, in the field of non-destructive evaluation (NDE) using eddy currents, the analysis of signals supplied by impulsive systems remains rather empirical and is often described by behavioural models resembling black boxes.

It is therefore necessary to have a method that can predict and analyze the interactions between waves in impulsive mode and any medium whose properties affecting the propagation of those waves may vary in three-dimensional space. It is necessary to have a method which allows modelling of complex media within a simple and flexible formulation. It is also necessary to have a method that makes possible a better understanding of the interactions of a wave with complex media in impulsive mode, to size experimental impulsive systems intended for the analysis of such media, and finally to characterize media based on experimental data.

### SUMMARY OF THE INVENTION

In order to overcome these technical problems, the principle of the method according to the invention consists of superimposing the wave/medium interactions taking place in harmonic mode at different frequencies in the medium considered.

These harmonic interactions are formulated using models arising from the distributed point source method—DPSM—elaborated in harmonic mode, which are then superimposed. The DPSM method is more fully described in documents WO 2004/044 790 and WO 2007/071 735, to which it is possible to refer for more information and which are incorporated here by reference.

The selection of the frequencies and of the superposition coefficients of the harmonic interaction models is made according to the Fourier series decomposition of the selected impulsive wave. It is possible to limit the impulsive model thus obtained to the first N harmonics. For example, in the case of interactions generated by a square wave signal of frequency F0 with a 10% duty cycle, the superposition of the first nine harmonic interaction models, elaborated for frequencies from F0 to 9*F0, which are included in the first lobe of the Fourier series decomposition, is enough to model the wave/medium interactions for this impulsive wave.

Thus, the method according to the invention enjoys the same advantages (semi-analytical, three-dimensional, matrix formulation, . . . ) and makes it possible in particular to handle complex media, such as media with interfaces, diffusive media, nonlinear media or even those having volume objects.

Further, the method according to the invention:
allows the modelling of three-dimensional wave/medium interactions in impulsive mode, for any impulsive signal shape;
is formulated in a simple, readily embeddable manner by superposition of harmonic mode interactions by the DPSM method;
allows the handling of complex media (diffusive, nonlinear, including volume objects);
allows the initial modelling problem to be decomposed into sub-problems: on the one hand, the contribution of each object included in the medium considered can be analyzed separately, and on the other hand the interactions connected with each of the harmonic components can be analyzed in isolation, which has the advantage of considerably simplifying the analysis of the problem considered;
is generic and applicable to different fields of physics (ultrasonics, acoustics, eddy currents, microwaves . . . ) provided that the equations of propagation in the medium considered are known;
allows handling of the inverse problem in impulsive NDE.

### BRIEF DESCRIPTION OF FIGURES

Other advantages and features of the invention will appear in the description of an embodiment given hereafter. In the annexed drawings:

FIG. 1 is a schematic illustrating the fundamental principle of the DPSM method;

FIG. 2 is a schematic illustrating the reconstitution of a transmitted field at an interface according to the DPSM method;

FIG. 3 is a schematic illustrating the distribution of the DPSM method point sources at the interfaces of FIG. 2;

FIG. 4 is an illustration of the application of the DPSM method in the case of an electrostatic sensor including two electrodes and a stratified medium;

FIGS. 5a and 5b illustrate the potential and the electric field between the two electrodes obtained by the DPSM method;

FIG. 6 is a schematic sectional view of a test sheath representing a prestressing cable;

FIG. 7 is a schematic sectional view of a simplified test sheath of FIG. 6;

FIGS. 8a and 8b illustrate a distribution of control points for the DPSM method applied to the sheath of FIG. 7;

FIG. 9 illustrates a display of equipotential lines and constant-value lines for the radial component of the electric field arising from the DPSM method applied to the sheath of FIG. 7;

FIG. 10 is a schematic of the capacitance coefficients of two conductors in a medium;

FIG. 11 shows measured or calculated capacitance curves as a function of position for the sheath of FIG. 7;

FIG. 12a illustrates the spectrum of a periodic signal with a 1/10 duty cycle used by the method according to the invention;

FIG. 12b illustrates a reconstruction of the signal of FIG. 12a using the first nine harmonics;

FIG. 13 shows the configuration of an air/water problem;

FIG. 14 illustrates the acoustic pressure in a plane transverse to the interface of the configuration of FIG. 13 using the DPSM method;

FIG. 15 illustrates a configuration of a stratified problem;

FIG. 16 illustrates the acoustic pressure in a plane perpendicular to the two interfaces of the configuration of FIG. 15 using the DPSM method;

FIG. 17 illustrates a configuration with a spherical obstacle;

FIGS. 18 and 19 illustrate the acoustic pressure in the case of a spherical obstacle of the configuration of FIG. 15 using the DPSM method;

FIGS. 20 through 23 respectively illustrate the acoustic pressure for the three foregoing configurations in impulsive mode by the method according to the invention; and

FIGS. 24a through 24l illustrate an application to an electromagnetic field of the method according to the invention in a configuration similar to that of FIG. 17.

### DESCRIPTION OF THE DISTRIBUTED POINT SOURCE METHOD OF MODELLING (DPSM METHOD)

The DPSM method is more fully described in documents WO 2004/044 790 and WO 2007/071 735, to which it is possible to refer for more information and which are incorporated here by reference. We will briefly recall its principles.

The DPSM method is a generic three-dimensional modelling method for systems including particularly sensors and transducers, which can currently be applied to fields such as electrostatics, electromagnetics or ultrasonics. The DPSM method requires knowledge of the equations of propagation in different media and their particular solution for the case of a point source (Green's function). It can be compared, on the basis of its principle, with boundary integral type methods, with methods of singularities or with BEM (boundary element methods), and requires only that the surfaces or interfaces between the objects comprising the problem be meshed. The DPSM method is based on a spatial distribution of point sources, arranged on both sides of the active surfaces of the objects. Its originality resides in the absence of approximation in the solution of boundary conditions between the objects of a problem, and its capacity to handle multiple interfaces between media.

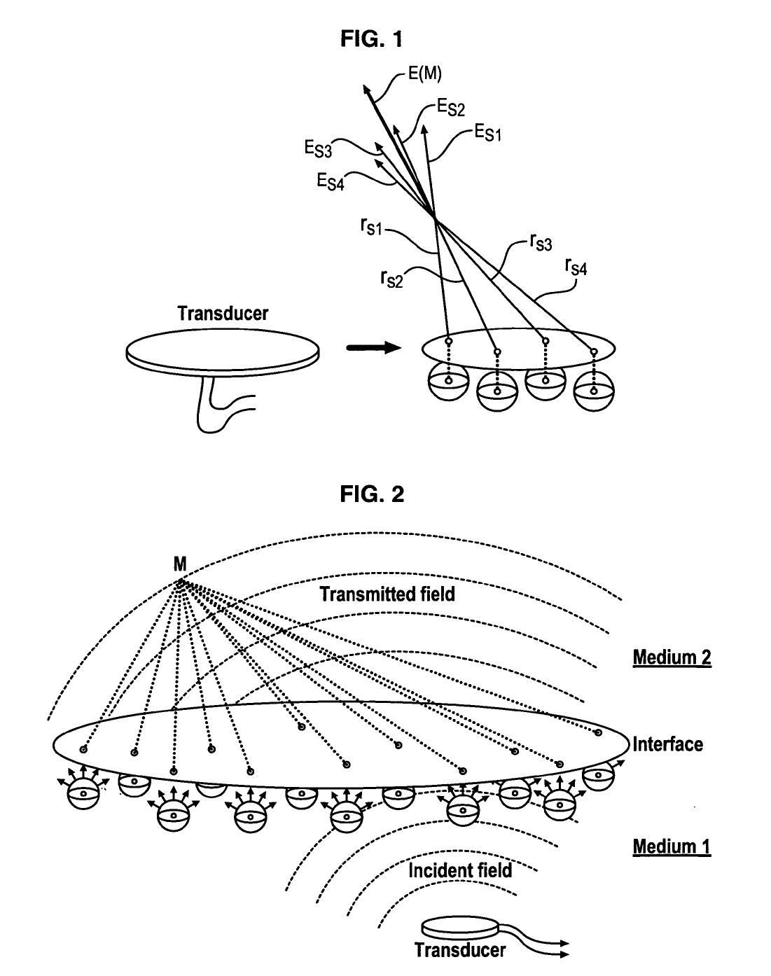

This semi-analytical calculation technique relies on the superposition of a set of “bright points” whose weights are determined so as to satisfy the set of boundary conditions of a problem. The principle therefore consists of substituting, for the objects present in a system to be modelled, layers of point sources located on both sides of their interfaces. The distribution of sources is associated with a regular mesh of control points located on the interfaces. These sources are intended to reconstitute the physical quantities (field, potential, pressure, etc.) present in the real problem, and are calculated to satisfy the boundary conditions at the control points distributed over all the interfaces. A simple example, developed within the framework of this section, allows the principle to be illustrated. The initial, complex problem will consequently become a problem whose solution will result from the superposition of a great number of elementary solutions due to each of the point sources. This concept is illustrated in FIG. 1, in which an active surface (a transducer, for instance) is represented by a set of point sources. The resulting fields are calculated by superposition of the elementary quantities.

The same principle is applied to interfaces: an array of “virtual” sources whose purpose is to synthesize the quantities reflected from and transmitted through the interface is disposed. FIG. 2 illustrates this principle for a field transmitted in a medium 2 by a transducer placed in a medium 1. This transducer can be that of FIG. 1.

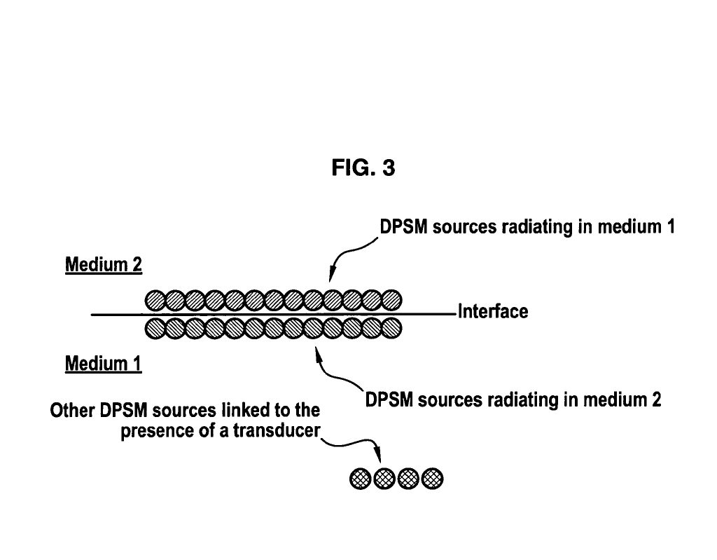

FIG. 3 shows the basic configuration: active element, and virtual sources at the interfaces between media. This configuration can be extended ad infinitum to undertake the modelling of very complex systems. The advantage of this approach is that the model is obtained in the form of a matrix, hence subsequently usable in optimization processes or signal processing.

In FIG. 3, which illustrates the distribution and the role of the “virtual” sources at the interfaces, it is seen that the sources located above the interface radiate into medium 1 (they synthesize the field reflected by the interface), while the sources located below the interface radiate only into medium 2 and synthesize the field transmitted through the interface.

The “weight” of each of the elementary sources, whose meshing is henceforth substituted for the active surfaces defined within the real problem, is determined using the boundary conditions between the different media (sensor surfaces, interfaces . . . ). By expressing these boundary conditions in the form of a global solution matrix and inverting it, the values of the sources according to the DPSM method can be obtained. The sources thus obtained make it possible to analytically calculate at any point in space a scalar quantity (potential, pressure . . . ) and the associated vector quantity (electric field, velocity . . . ).

The technique has advantages, particularly the possibility of separating the effects of sources connected with the various objects (suppression of inductor sources so as to perceive only the signature of a flaw). The technique also makes it possible to easily create animations: when the geometry of an object is changed, only the interfaces need to be re-meshed (and not the entire working volume). The result is a rapidity of calculation that makes possible the achievement of “quasi-real time” performance.

### Illustration Using a Simple Electrostatic Case

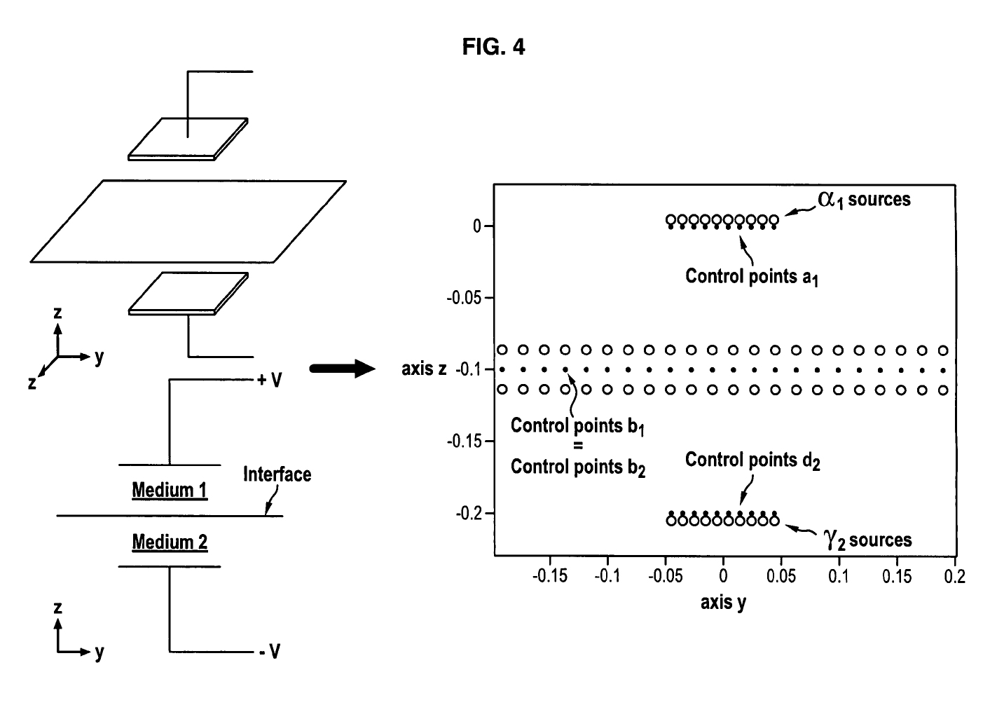

We will present here a very simple example of the use of the DPSM method in electrostatics: a flat-plate capacitor in which two dielectric media are inserted (FIG. 4).

The first step in solution by the DPSM method consists of meshing the active surfaces of the problem (here, the two electrodes): this makes available an array of control points (continuity conditions are checked at these points) and an array of sources. The same treatment is applied to the interface on both sides of which networks of sources are distributed to synthesize the transmitted and reflected fields. The equations characterizing this problem are derived from Maxwell's equations expressed in a quasi-stationary regime (QSSA), which implies decoupling into an electric field \vec{E} and a magnetic field \vec{B}. One obtains:

Rot(\vec{E})=0, which implies \vec{E}=−grad(V), and Div(\vec{E})=ρ/ε₀, which leads to ∇(V)=ρ/ε₀. A particular solution to this Laplace equation in spherical coordinates, for an isotropic point source, is given by Equation [2] below.

The second step consists of expressing the boundary conditions of the problem. We distinguish the intrinsic boundary conditions (IBC) at the interface between two dielectric media, from the user boundary conditions (UBC) which impose for example the excitation conditions on the electrodes. The IBCs induce the continuity of the potential V and the continuity of the normal component of \vec{D}=ε.\vec{E} [1].

The expression of the continuity conditions will be constructed using the coupling matrices whose calculation is presented below. In the case of FIG. 1 (a single target point and Nₛ point sources), the potential and the component in the z direction of the electric field are written:

$$V ( M ) = \frac{1}{4 π {ɛ}_{0} {ɛ}_{r}} {\sum }_{i = 1}^{{N}_{s}} \frac{{a}_{i}}{{r}_{{S}_{i}}} and \\ {E}_{z} ( M ) = \frac{1}{4 {πɛ}_{0} {ɛ}_{r}} {\sum }_{i = 1}^{{N}_{s}} \frac{( {z}_{M} - {z}_{i} ) {a}_{i}}{{r}_{{S}_{i}}^{3}} \qquad [ 2 ]$$

In the case of Nₚ target points and Nₛ source points, the potential and the component in the z direction of the field can be written in matrix form:

$$( \begin{matrix}{V}_{1} \\ ⋮ \\ {V}_{{N}_{p }}\end{matrix} ) = ( \begin{matrix}{M}_{11} & … & {M}_{1 {N}_{s}} \\ ⋮ & & ⋮ \\ {M}_{{N}_{p} 1} & … & {M}_{{N}_{p} {N}_{s }}\end{matrix} ) \cdot ( \begin{matrix}{a}_{1} \\ ⋮ \\ {a}_{{N}_{s}}\end{matrix} ) \\ ( \begin{matrix}{E}_{{z}_{1}} \\ ⋮ \\ {E}_{{z}_{{N}_{p}}}\end{matrix} ) = ( \begin{matrix}{Q}_{11}^{z} & … & {Q}_{1 {N}_{s}}^{z} \\ ⋮ & & ⋮ \\ {Q}_{{N}_{p} 1}^{z} & … & {Q}_{{N}_{p} {N}_{s}}^{z}\end{matrix} ) \cdot ( \begin{matrix}{a}_{1} \\ ⋮ \\ {a}_{{N}_{s}}\end{matrix} ) \qquad [ 3 ]$$

These terms are the coupling matrices M_{target-sources} and Q^{z}_{target-sources} between the source points and points selected as targets (control points for instance), which allow calculation of the potential and the normal component of the electric field (here along the z axis). Their terms Mᵢⱼ and Q^{z}ᵢⱼ are respectively written:

$${M}_{ij} = \frac{1}{4 π {ɛ}_{0} {ɛ}_{r} {r}_{ij}} and \\ {Q}_{ij}^{z} = \frac{{z}_{i} - {z}_{j}}{4 π {ɛ}_{0} {ɛ}_{r} {r}_{ij}^{3}} \qquad [ 4 ]$$

The continuity conditions at the interface (IBC) are written:

$$\{ \begin{matrix}{V}_{1} = {V}_{2} \\ {ɛ}_{{r}_{1}} {E}_{{n}_{1}} = {ɛ}_{{r}_{2}} {E}_{{n}_{2}}\end{matrix} \qquad [ 5 ]$$

These conditions can be expressed from the coupling equations between the sources of the DPSM method and the test points concerned, by retaining the notations used for M and Q:

$$\{ \begin{matrix}{M}_{{b}_{1} {α}_{1}} \cdot {α}_{1} + {M}_{{b}_{1} {δ}_{1} } \cdot {δ}_{1} = {M}_{{b}_{2} {γ}_{2}} \cdot {γ}_{2} + {M}_{{b}_{2} {β}_{2}} \cdot {β}_{2} \\ {ɛ}_{{r}_{1}} ( {Q}_{{b}_{1} {α}_{1}}^{z} \cdot {α}_{1} + {Q}_{{b}_{1} {δ}_{1 }}^{z} \cdot {δ}_{1} ) = {ɛ}_{{r}_{2}} ( {Q}_{{b}_{2} {γ}_{2}}^{z} \cdot {γ}_{2} + {Q}_{{b}_{2} {β}_{2}}^{z} \cdot {β}_{2} )\end{matrix} \qquad [ 6 ]$$

Likewise, there appear boundary conditions on the electrodes which are user boundary conditions (UBC): it is the user who imposes the voltage values on the electrodes at Vₛ₁ and V_{d2}:

$$\{ \begin{matrix}{V}_{{a}_{1}} = {M}_{{a}_{1} {α}_{1}} \cdot {α}_{1} + {M}_{{a}_{1} {δ}_{1}} \cdot {δ}_{1} \\ {V}_{{d}_{2}} = {M}_{{d}_{2} {γ}_{2}} \cdot {γ}_{2} + {M}_{{d}_{2} {β}_{2}} \cdot {β}_{2 }\end{matrix} \qquad [ 7 ]$$

The IBCs and UBCs are then combined (equations [6] and [7]):

$$( \begin{matrix}{V}_{{a}_{1}} \\ {V}_{{d}_{2}} \\ 0 \\ 0\end{matrix} ) = ( \begin{matrix}{M}_{{a}_{1} {α}_{1}} & 0 & {M}_{{a}_{1} {δ}_{1}} & 0 \\ 0 & {M}_{{d}_{2} {γ}_{2}} & 0 & {M}_{{d}_{2} {β}_{2}} \\ {M}_{{b}_{1} {α}_{1}} & - {M}_{{b}_{2} {γ}_{2}} & {M}_{{b}_{1} {δ}_{1}} & - {M}_{{b}_{2} {β}_{2}} \\ {ɛ}_{{r}_{1}} {Q}_{{b}_{1} {α}_{1}}^{z} & - {ɛ}_{{r}_{2}} {Q}_{{b}_{2} {γ}_{2}}^{z} & {ɛ}_{{r}_{1}} {Q}_{{b}_{1} {δ}_{1}}^{z} & - {ɛ}_{{r}_{2}} {Q}_{{b}_{2} {β}_{2 }}^{z}\end{matrix} ) \cdot ( \begin{matrix}{α}_{1} \\ {γ}_{2} \\ {δ}_{1} \\ {β}_{2}\end{matrix} ) \qquad [ 8 ]$$

Inversion of this matrix system gives the numerical value of each point source, which then allows the calculation of the quantities in the entire problem space.

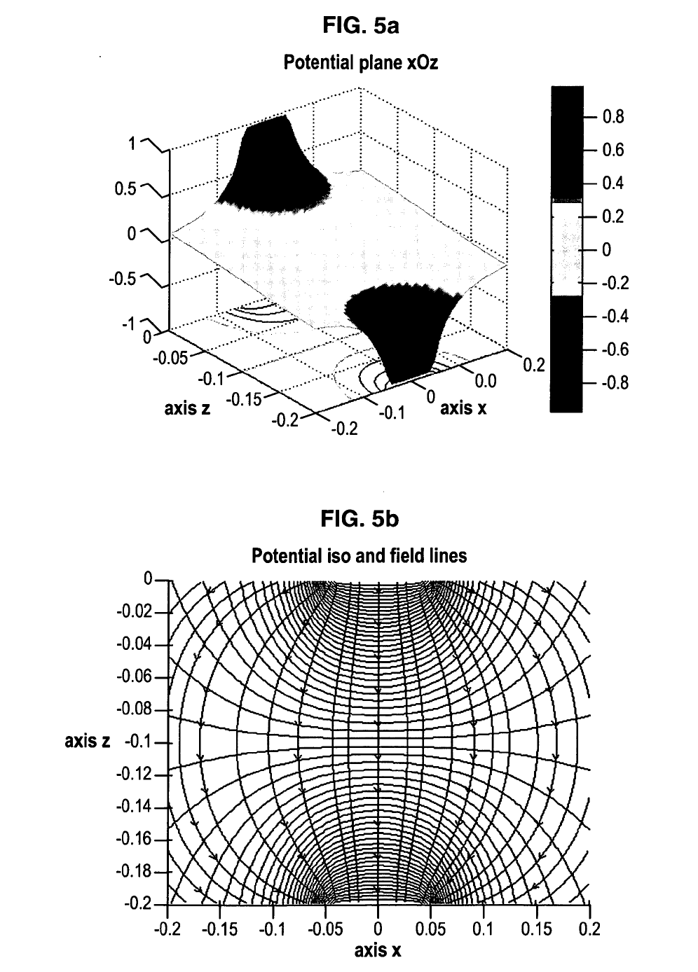

One original way of testing the quality of this model is presented in FIGS. 5a and 5b. The dielectric properties of media 1 and 2 have been selected to be identical, in order to illustrate the very good continuity of the quantities at the interface which has become “fictitious,” since the media are the same.

### Application to an Industrial Problem

### Presentation of the Problem

Many artificial works, in particular concrete bridges, employ external prestress, either during construction or during reinforcement of the structure.

Prestressing cables are generally placed in sheaths made of high density polyethylene (HDPE), where the remaining space is filled under high pressure with a grout made of a hydraulic binder or of petroleum-based wax. For several years, administrators have had to deal with a resurgence of breakage affecting the elementary wires, then strands, even entire cables, in areas not protected by the grout, particularly in the presence of air or water pockets.

The objective consists essentially of detecting injection faults in the sheaths, and non-destructive means are preferred over inspection procedures that are destructive (an endoscopic camera, for example, which requires that the sheath be opened), or complicated to implement (gamma rays). The standard method today remains hammer testing, which consists of tapping on the sheath and listening directly to the sound that is emitted so as to detect voids. This checking technique is supplemented by a capacitive probe. The metal electrodes of the probe placed on the surface of the sheath form a capacitor whose capacitance varies depending on the nature of the materials through which the field lines pass. Corrosion products can be advantageously characterized by the variation in their permittivity. A capacitance measurement, carried out on the outside of the tube, can therefore contribute relevant information if it is possible to reconstruct information on the permittivities of the media inside the sheath. The capacitive sensor can move longitudinally, along the z axis, and rotate around the sheath through an angle θ.

We present here a modelling of the capacitive probe by the DPSM method associated with a prestress sheath typical of the problem. Calculations carried out on such a product have been programmed and compared to finite-element calculations, as well as to experimental quantities obtained on test bodies of known geometry.

### Comparison with Experimental Data

a. The Test Sheath

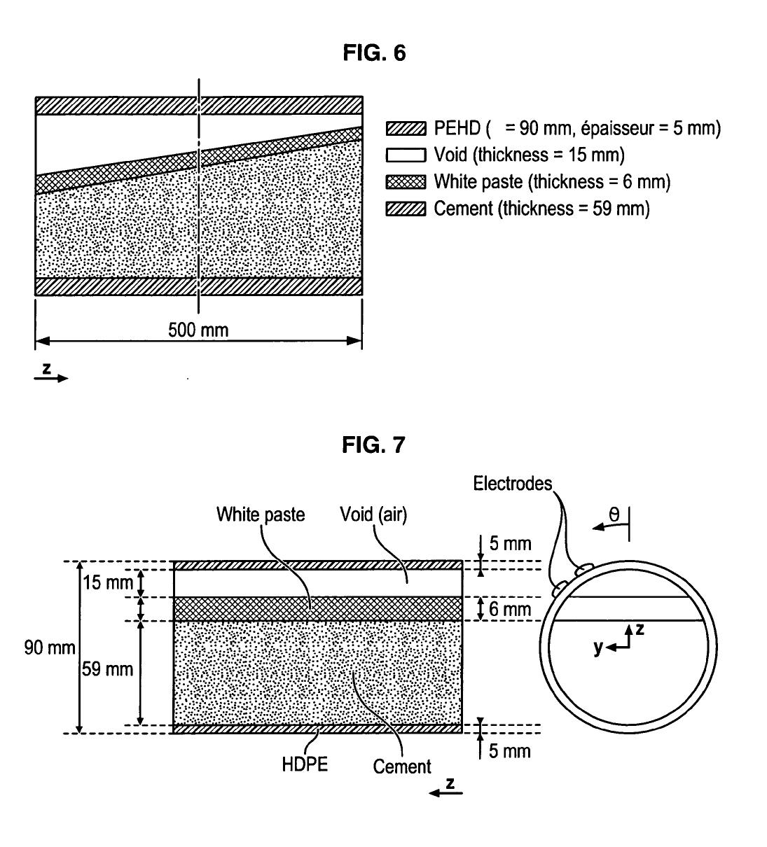

A series of test bodies is available, having known defects. The simplest that we have is shown in FIG. 6. The sheath, without metal strands, is made up of three layers of material: cement, white paste and an air void, whose thicknesses vary along the length of the sheath. Rotated measurements (0°<θ<360°) have been carried out for a fixed value of z=265 mm.

This configuration is very close to reality from the electrostatic point of view, the corrosion products being in the upper part of the sheath and the cables in its lower part.

b. Modelling of a Typical Sheath

To undertake the modelling of our problem, we have decided to concentrate on a simplified sheath (FIG. 7). The simulated sheath is similar to the test sheath.

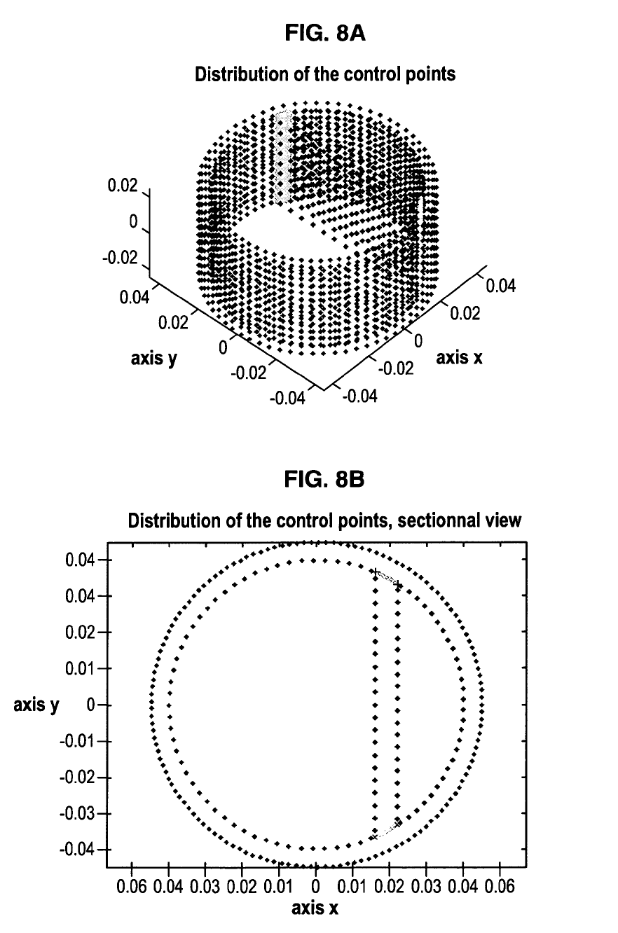

The following figures (FIGS. 8a and 8b) show the distribution of the control points for the DPSM method: it is at these points that the boundary conditions are expressed. Each DPSM test point is associated with two sources located on either side of the interface between the two media to simulate the transmitted or reflected waves or quantities in each medium. In FIGS. 8a and 8b, these source points are not shown.

c. Visualization of the Solution

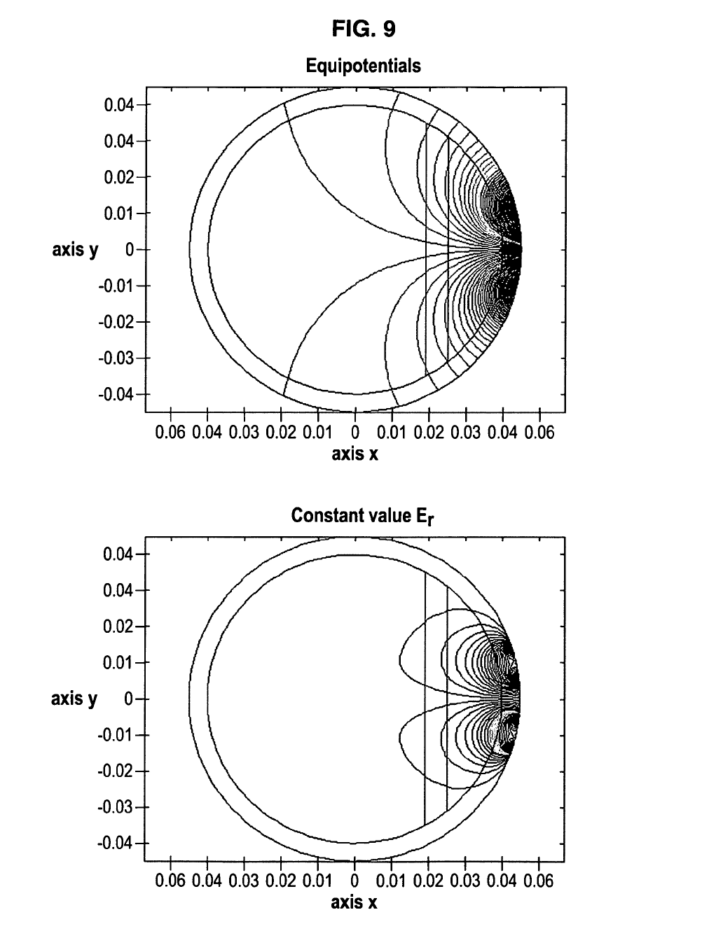

Once the DPSM method meshing is accomplished (arrangement of the control points and the sources at the interfaces and surfaces of the transducers), the boundary conditions for each interface are written as a function of the coupling matrices defined previously. The equations are put into a global matrix form. The inversion of this matrix gives the numerical value of each source point, which then makes it possible to calculate the quantities throughout the problem space. FIG. 9 illustrates the calculation of the potential and of the electric field in a particular case: all the media represented in the sheath have been selected to be identical (i.e. the permittivity value of every medium is identical). This allows us to emphasize the very good continuity of the quantities at the interface which has been made “fictitious,” as the media are the same. The quantities are shown in a plane transverse to the sheath for an electrode position at θ=0°.

d. Capacitance Calculation

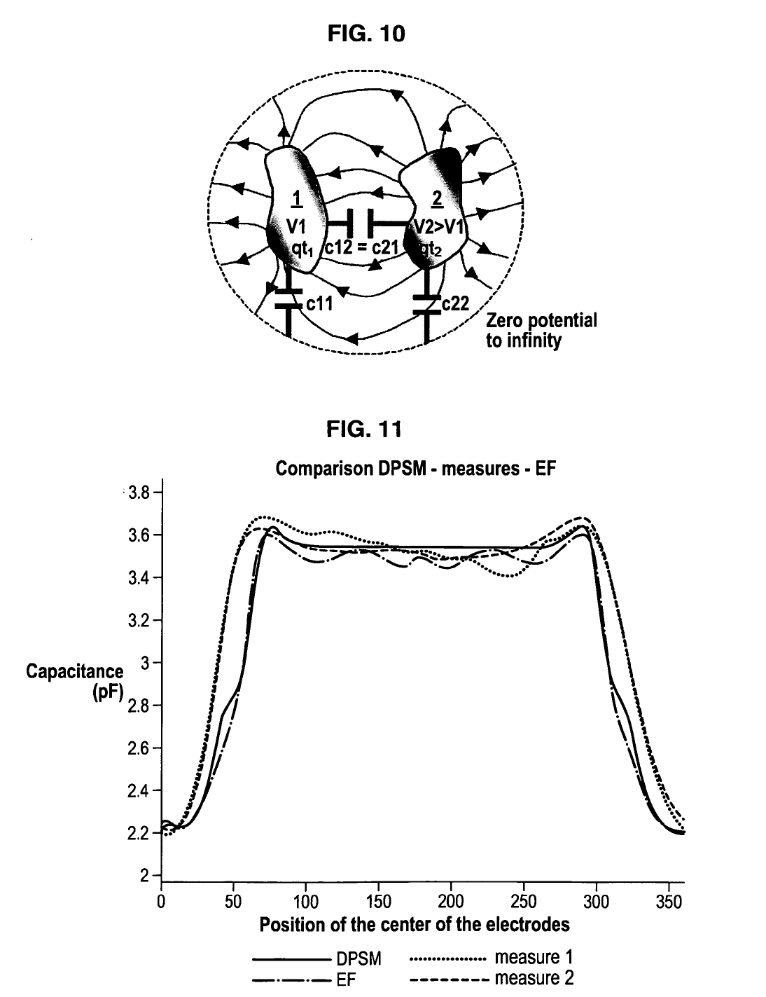

The capacitance value is calculated using the source values from the DPSM method corresponding to the surfaces of the electrodes. Recall the equations employed when two charged conductive objects are put into influence. The electrostatic equilibrium can be written:

$$\{ \begin{matrix}q {t}_{1} = {c}_{11} \cdot {V}_{1} + {c}_{12} \cdot {V}_{2} \\ q {t}_{2} = {c}_{21} \cdot {V}_{1} + {c}_{22} \cdot {V}_{2 }\end{matrix} \qquad [ 9 ]$$

where cᵢⱼ are coefficients which depend only on the geometric configuration.
This configuration can be described by the following scheme (FIG. 10):
The field lines are essentially concentrated between the two conductors, those which go to infinity show that the system is not completely in influence.

By using the general definition of capacitance and the foregoing equations, the expression which gives q as a function of the voltage difference V₂-V₁ and the capacitance of the system can be obtained:

$$q = capa ( {V}_{2} - {V}_{1} ) with capa = \frac{{c}_{11} \cdot {c}_{22} - {c}_{12} \cdot {c}_{21}}{{c}_{11} + {c}_{22} + {c}_{12} + {c}_{21}} \qquad [ 10 ]$$

By using different excitation voltages, all the coefficients cᵢⱼ be calculated, and the capacitance value wanted is then obtained.

e. Measurements/Simulations Comparison

Once the meshing of the “typical” sheath for the DPSM method and the capacitance calculation algorithm were accomplished, we carried out comparisons between measurements and simulations to validate our model.

We also compared our model with 2D finite-element simulations carried out with the commercial software COMSOL. All these simulations and measurements appear in FIG. 11 where the capacitance value is shown as a function of the position of the centre of the electrodes.

Good consistency between measurements and the simulation based on the DPSM method is first observed. A certain lack of repeatability in the experimental data is noted, however, by observing the two measurements carried out in succession (measurement curves 1 and 2). The greatest difference occurs in the middle of the curve (these positions correspond to the case where the electrodes are located in the lower part of the sheath, when they are facing the area of the sheath that is filled with cement). Another difference appears when the centre of the electrodes is near 45° (these positions correspond to the entry of the first electrode into the white paste zone), where the simulation based on the DPSM method (as well as the finite-element simulations) shows a stronger inflection point than that measured. This can be due to the difference between the simulation with constant thickness (FIG. 7) and that of the measurements where the thickness is variable (FIG. 8), and in which the change in thicknesses within the length of the electrodes (10 cm) can have a non-negligible effect.

This figure also allows us to consider the comparison between the DPSM method based simulation and that based on the finite-element (FE) method. The finite-element simulation shows a kind of oscillation when the electrodes are in the lower part of the sheath. This can come from a meshing problem. The DPSM allows objects to be easily moved with respect to each other: this only requires calculation of a new global solution matrix. That is not the case for finite elements: each time an object is moved, a new complete meshing has to be carried out, which can cause deviations in calculating the quantities.

### Impulsive Mode DPSM Method

The method according to the invention is an impulsive mode DPSM method which uses the superposition of isochronous modes deduced from the Fourier series decomposition of the excitation signal. For example, it is noted that a rectangular signal of amplitude A and duty cycle α=θ/T can be correctly synthesized if only the harmonics located under the first lobe of the spectral envelope H(f) are retained, which cancels at frequencies that are multiples of 1/θ:

H(f)=A*(θ/T)*sin(π.ƒ.θ)/π.ƒ.θ=A*(θ/T)*sin c(f) [11]

The advantage of this method appears clearly at the experimental level, by making the passband of the instrumentation (naturally limited) coincide with the width of the first lobe. The quality of the reconstituted signal will be greater the lower the duty cycle, the number of components being greater.

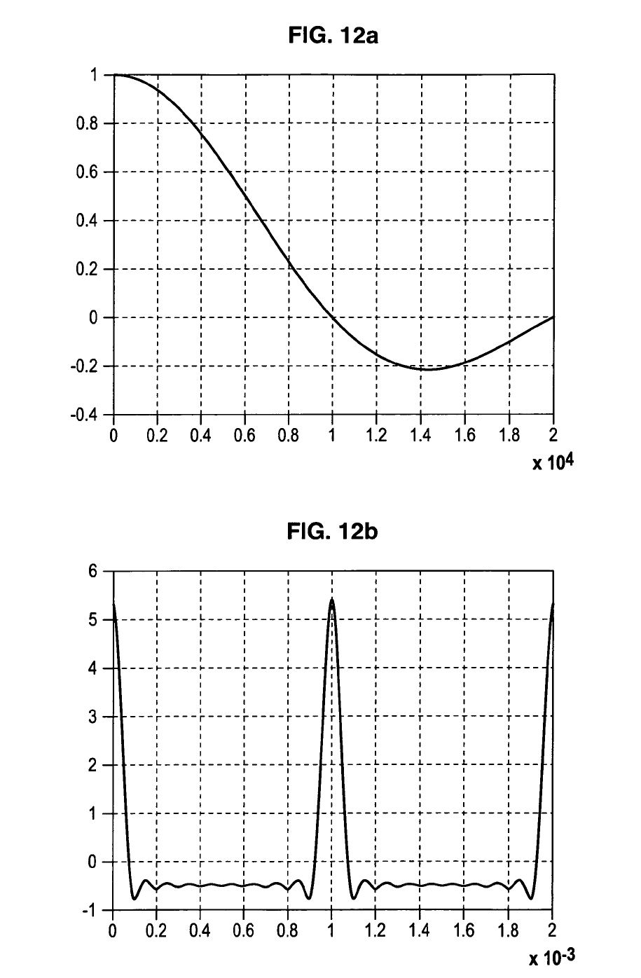

In the example below, A=10, F=1/T=1000 Hz, and α=θ/T=0.1. The first ten harmonics are contained under the first lobe (the tenth harmonic is zero; it corresponds to frequency 1/θ). The signal obtained, made up of these first nine harmonics, is shown in FIG. 12b.

Overall, the method according to the invention will, for each of the harmonics, calculate a model using the DPSM method as previously presented. Then, the set of models thus obtained is superimposed, possibly with a weighting coefficient, in order to obtain the final model of the impulsive mode being considered.

### Presentation of the DPSM Method in Ultrasonics

The DPSM method also applies to the solution of problems involving equations of propagation or diffusion of waves (partial differential equations of D'Alembert, of Helmholtz, etc.). As in the foregoing case (Equations 2), the method requires knowledge of the particular solution of these equations for a point source operating in the different media of the problem (Green's functions). In this part, we present via a simple example the equations needed for the solution of a problem in the field of ultrasonics by the DPSM method.

Let us consider for instance a basic configuration: a transducer facing an interface separating two media (similar in configuration to that of FIG. 3).

In acoustics, the continuity conditions at the interfaces apply to the pressure and to the normal component of velocity at the interface multiplied by the density of the medium:

$$\{ \begin{matrix}{P}_{1} = {P}_{2} \\ {ρ}_{1} \cdot {V}_{1 n} = {ρ}_{2} \cdot {V}_{2 n}\end{matrix} \qquad [ 12 ]$$

The foregoing equations are then expressed using the sources of the DPSM method and so-called “acoustic” coupling matrices. These coupling matrices are calculated as in the foregoing case. Their elements have the following form:

$$\begin{matrix}{M}_{ij} = - if ρ vds \frac{{e}^{i {kR}_{ij}}}{{R}_{ij}} & [ 13 ] \\ {Q}_{ij}^{z} = \frac{- vds}{2 π} \frac{{R}_{{z}_{ij}}}{{R}_{ij}^{3}} ( {ikR}_{ij} - 1 ) {e}^{i {kR}_{ij}} & [ 14 ]\end{matrix}$$

where ƒ is frequency, v the vibration speed of the source, ds the elementary meshing area, Rᵢⱼ the distance between the i^{th} source and the j^{th} target point and R_{zij} the distance in the z direction between the i^{th} source and the j^{th} target point.

M_{target-sources} corresponds to the acoustic pressures coupling matrix and Q^{z}_{target-sources} to the acoustic speeds coupling matrix (calculated here along its normal component, assumed in our example to be identical with the z axis).

Equations [12] are then rewritten:

$$\{ \begin{matrix}{M}_{aJ} \cdot J + {M}_{{aJ}_{1}} \cdot {J}_{1} = {M}_{{aJ}_{2}} \cdot {J}_{2} \\ {ρ}_{1} ( {Q}_{aJ}^{z} \cdot J + {Q}_{{aJ}_{1}}^{z} \cdot {J}_{1} ) = {ρ}_{2} {Q}_{{aJ}_{2 }}^{z} \cdot {J}_{2}\end{matrix} \qquad [ 15 ]$$

To show another aspect of the DPSM method formulation, a somewhat peculiar user boundary condition is set on the sources J connected to the transducer: it is the user himself who assigns weights even to the excitation source points. One can then write J=Id.J, and the problem is then obtained in its matrix form:

$$( \begin{matrix}J \\ 0 \\ 0\end{matrix} ) = ( \begin{matrix}Id & 0 & 0 \\ {M}_{aJ} & {M}_{{aJ}_{1}} & - {M}_{{aJ}_{2}} \\ {ρ}_{1} {Q}_{aJ}^{z} & {ρ}_{1} {Q}_{{aJ}_{1}}^{z} & - {ρ}_{2} {Q}_{{aJ}_{2}}^{z}\end{matrix} ) \cdot ( \begin{matrix}J \\ {J}_{1} \\ {J}_{2}\end{matrix} ) \qquad [ 16 ]$$

By inverting the matrix, the values of the sources J₁ and J₂, located respectively above and below the interface, can be determined. The examples developed later will illustrate the method in more complex cases: one or two interfaces, interaction of the wave with a refracting or diffracting object (an air bubble in water for example). The results will be presented in isochronous mode and in impulsive mode.

### Application to Ultrasonics in Isochronous Mode

### Air/Water Interface

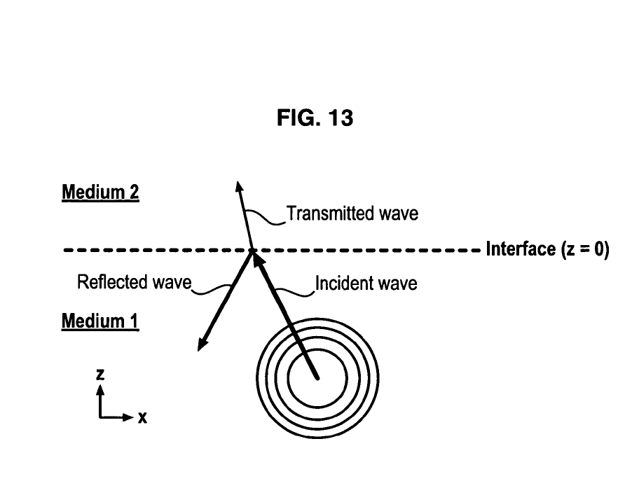

Let us consider the following configuration (FIG. 13): a single isotropic point source emitting a harmonic signal of frequency 200 kHz and vibrating with a speed v=1 m/s is placed in a medium 1 (air) having an interface with medium 2 (water).

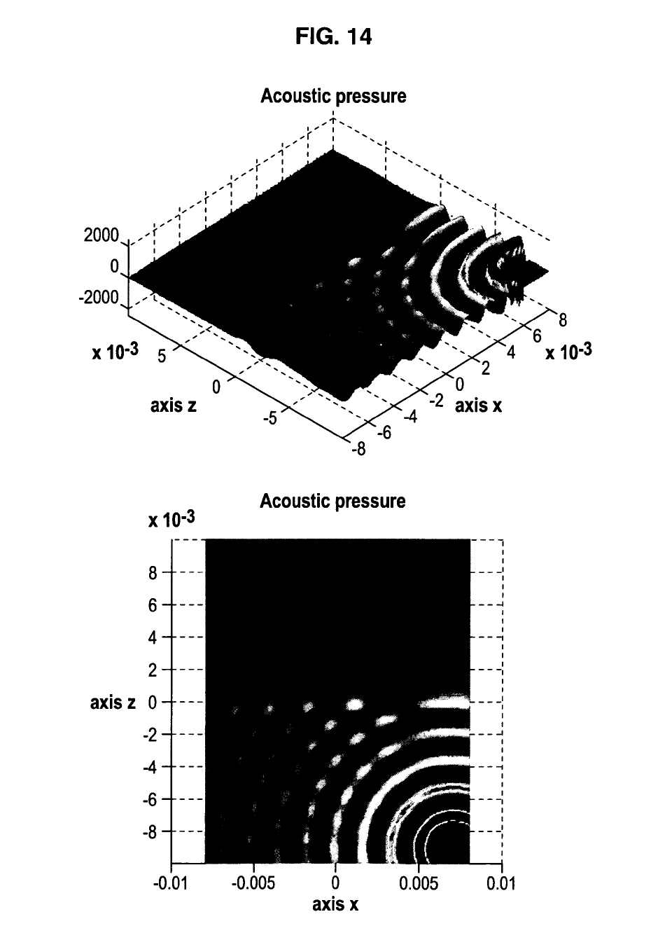

The images (FIG. 14) of the acoustic pressure in a transverse plan allow us to observe several phenomena. The waves transmitted in the water are observable above the interface; the difference in wavelength is easily seen. The reflected waves can be observed via the phenomenon of interference with the incident waves. From these data, all the macroscopic quantities can be calculated, and in particular the acoustic impedances, the transmission and reflection coefficients, etc.

### Stratified Medium

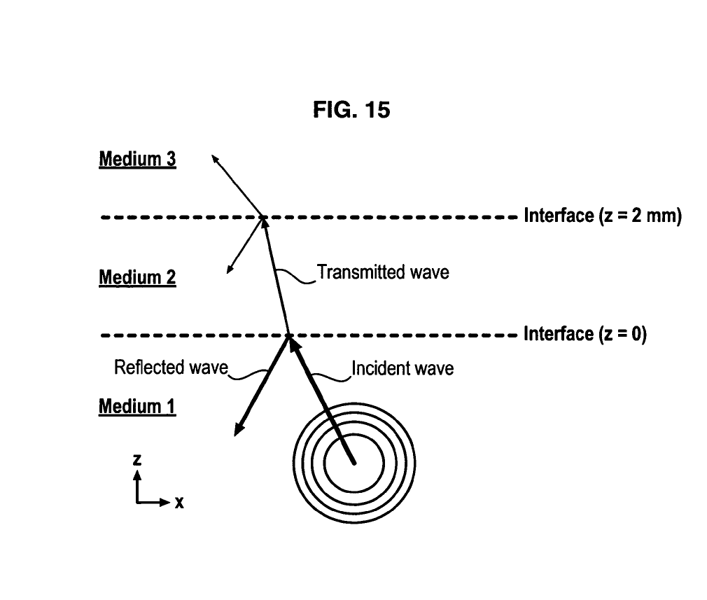

The case of a stratified medium (FIG. 15) is considered:

The media considered are ethyl benzol, water and glycerine. These three media have similar physical properties: this allows us to obtain transmitted and reflected waves at each interface. Here the operating frequency is 1 MHz.

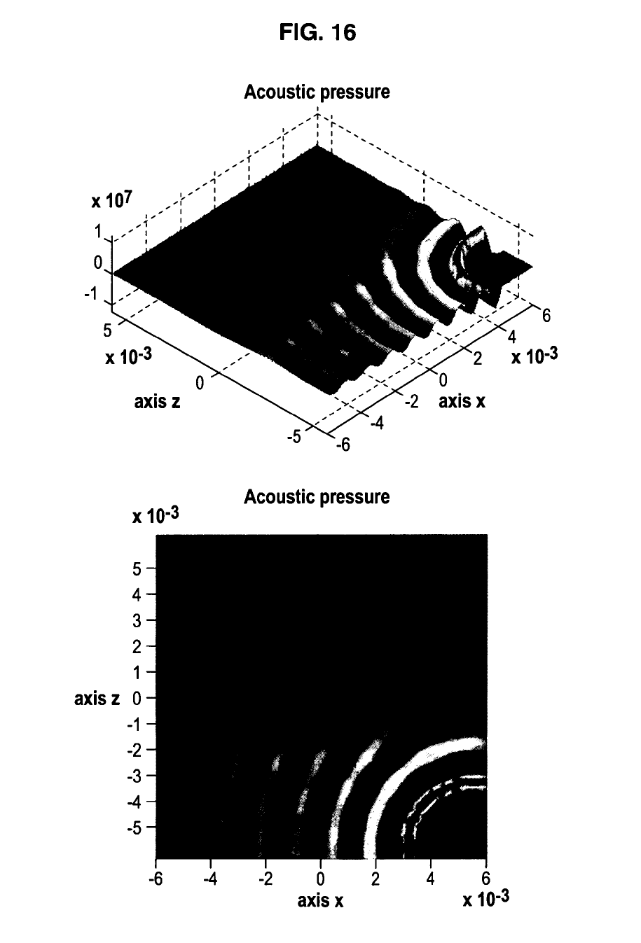

It is noted that in FIG. 16, as in the foregoing cases, the pressure curves are correctly connected at the interfaces. This continuity indicates that the networks of point sources radiating into the different media correctly synthesize the physical quantities on both sides of the interfaces.

### Spherical Obstacle

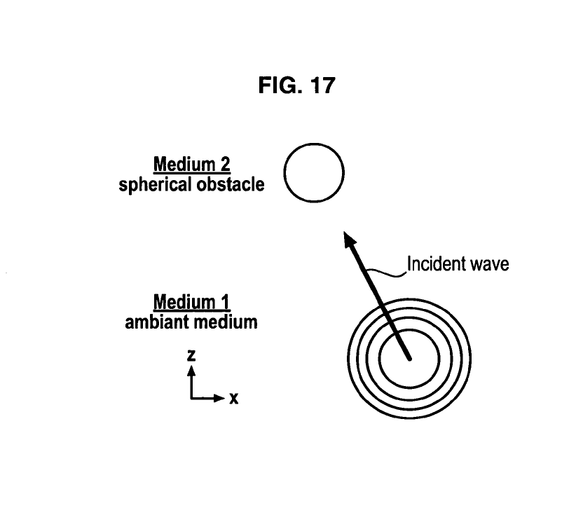

The case where a three-dimensional obstacle is placed on the trajectory of the incident wave (FIG. 17) is now considered. An object with dimensions greater than the wavelength is first considered, then one that is smaller, to illustrate the difference in wave diffraction.

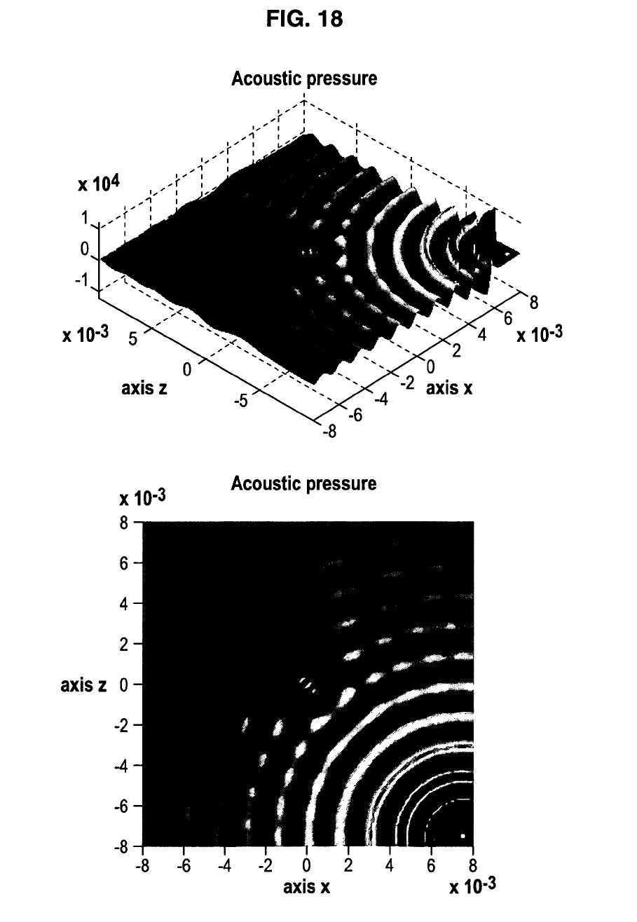

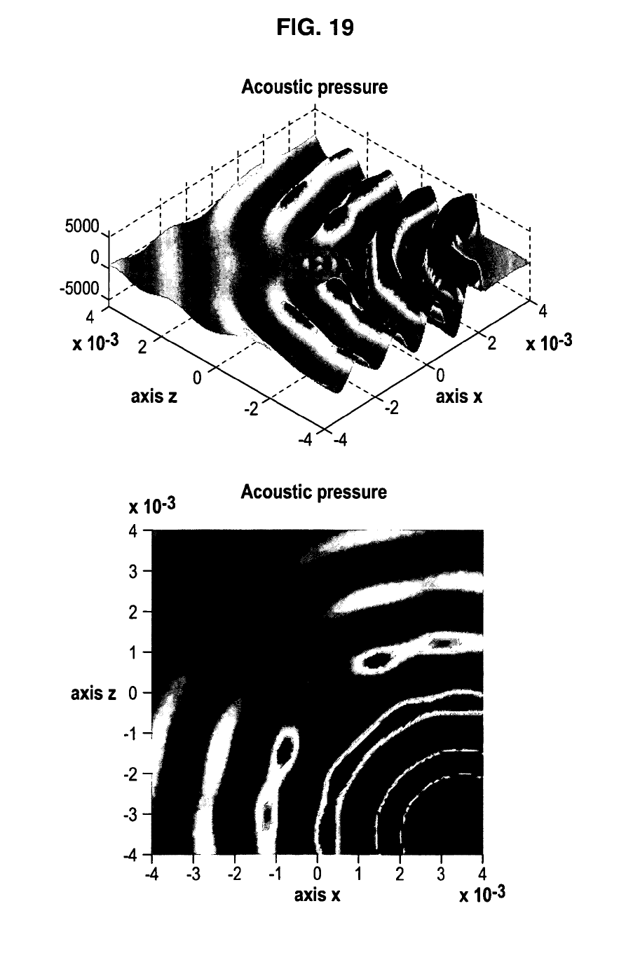

FIGS. 18 and 19 show the acoustic pressure in the configuration of FIG. 17. The pressure field has been calculated in the case of an air bubble in water, the frequency being 1 MHz. The diameter of the bubble has been chosen arbitrarily as an integer multiple of the wavelength in air: here we have used a bubble with radius R=1.53 mm (the diameter of the bubble is equal to nine times the wavelength in air). The wavelength in air is equal to λ₂=0.34 mm.

FIG. 18 illustrates in a remarkable manner the phenomena connected with the presence of this resonating cavity, in particular the formation of stationary waves within the bubble. The most interesting one, which naturally does not appear on these figures calculated here at a fixed time t, consists of introducing a time variation as a parameter. An animation of the curves is then obtained, which has obvious pedagogical potential.

FIG. 19 illustrates the phenomenon of diffraction: the diameter of the sphere has been selected equal to the wavelength in water. The wavelength in water being λ₁=1.48 mm (the operating frequency is still 1 MHz), the radius of the bubble is R=0.74 mm here.

A diffraction pattern is clearly seen to appear and to superimpose itself on the incident waves in the vicinity of the bubble: the presence of maxima and minima on each wavefront, as well as the transmission of a “plane” wave behind the diffracting object.

### Application to Ultrasonics in Impulsive Mode

The use of the impulsive mode is a common practice in NDT (non-destructive testing); it makes it possible to dispense with the presence of a possible stationary state and can facilitate the extraction of parameters from the incoming signals.

The operation of the method according to the invention rests on assumptions stated in the foregoing paragraph entitled “DPSM method in impulsive mode,” and superimposes the components resulting from the Fourier series decomposition of a train of impulses. The frequencies are naturally different from those used as an example in said paragraph, the shape of the impulse remains the same ( 1/10 duty cycle, the first nine harmonics are retained).

We present here the modelling of the three configurations considered in the foregoing paragraph, according to this impulsive excitation mode. The existence of the limiting angle (total reflection) can be noted, as well as the phenomenon of refraction. As we have previously emphasized, these images can be animated as a function of time or of a spatial parameter (displacement of objects in the sensor's field). The media are considered to be non-dispersive but it is easy to tabulate the different values of their physical properties as a function of frequency. It is possible for example to model the decomposition of a harmonic-rich wave by a prism.

### Air/Water Interface in Impulsive Mode

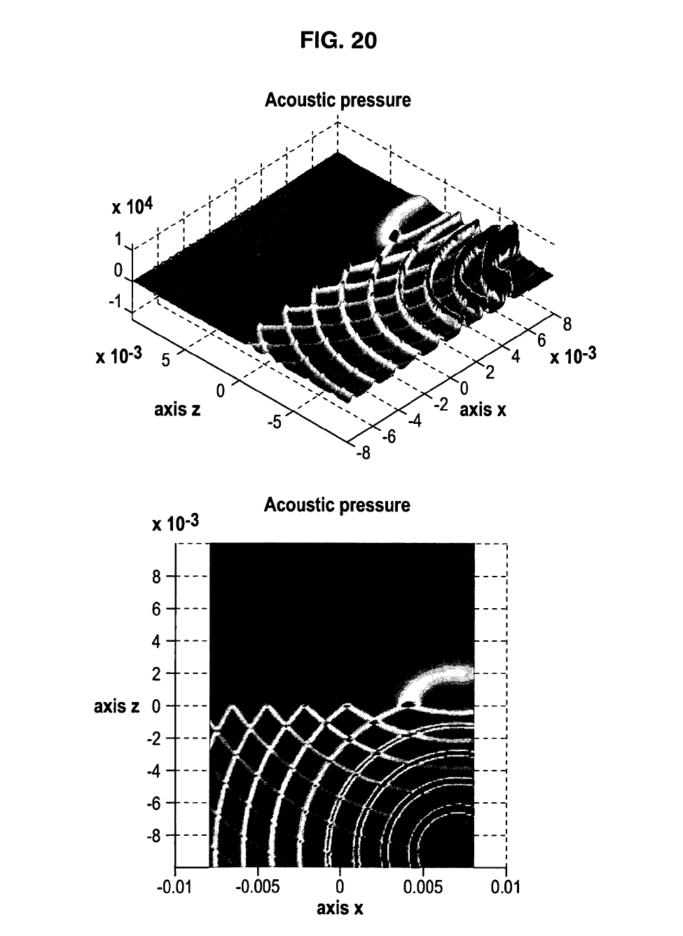

Let us return to the configuration of FIG. 13. The source now emits an impulsive signal of frequency ƒ=200 kHz. FIG. 20 shows the acoustic pressure in a plane transverse to the air/water interface containing the source.

The impulsive mode allows us to more easily observe the waves reflected at the interface. Further, the existence of the limiting angle (total reflection) can be noted. The value of the limiting angle is identical for each frequency (non-dispersive medium) and is calculated using:

$${θ}_{limiting} = arcsin ( \frac{{c}_{air}}{{c}_{water}} ) and \\ equals {θ}_{limiting} \approx 13 ° \qquad [ 17 ]$$

This value can be found in FIG. 20. The coordinates of the source are (0.007; −0.009); waves will not be transmitted starting with abscissa x_{limiting}:

x_{limiting}=0.007−tan (θ_{limiting})·0.009≈0.005 [18]

### Stratified Medium in Impulsive Mode

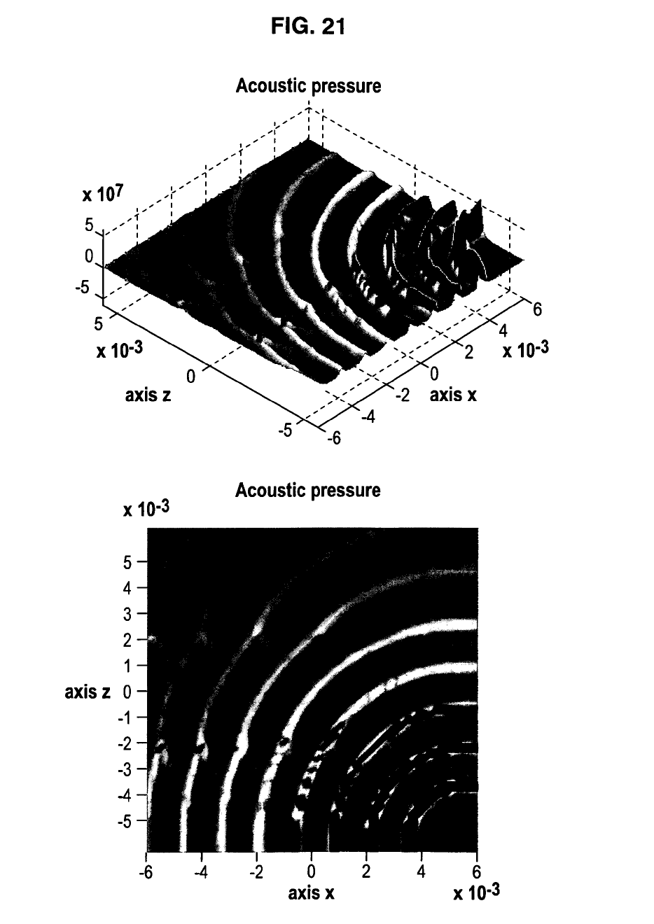

FIG. 21 shows the acoustic pressure in the case of a stratified medium, the frequency being 200 kHz and the media considered being identical to those of FIG. 16.

The impulsive mode allows us to visualize the transmitted and reflected waves at both interfaces. Here, the media having very similar speeds, the limiting angles are high compared with the case of the air/water interface; it is therefore very hard to observe them in FIG. 21 considering the visualization range (x_{limiting1}≈−6.2 mm):

$${θ}_{limiting 1} = arcsin ( \frac{{c}_{ethyl}}{{c}_{water}} ) = arcsin ( \frac{1340}{1480} ) \approx 64 ° \\ {θ}_{limiting 2} = arcsin ( \frac{{c}_{water}}{{c}_{glycerine}} ) = arcsin ( \frac{1480}{1920} ) \approx 50 ° \qquad [ 19 ]$$

### Spherical Obstacle in Impulsive Mode

To complete these different approaches, we present an example of an air bubble in water with an impulsive source of frequency 200 kHz, the radius of the bubble being R=0.7 mm.

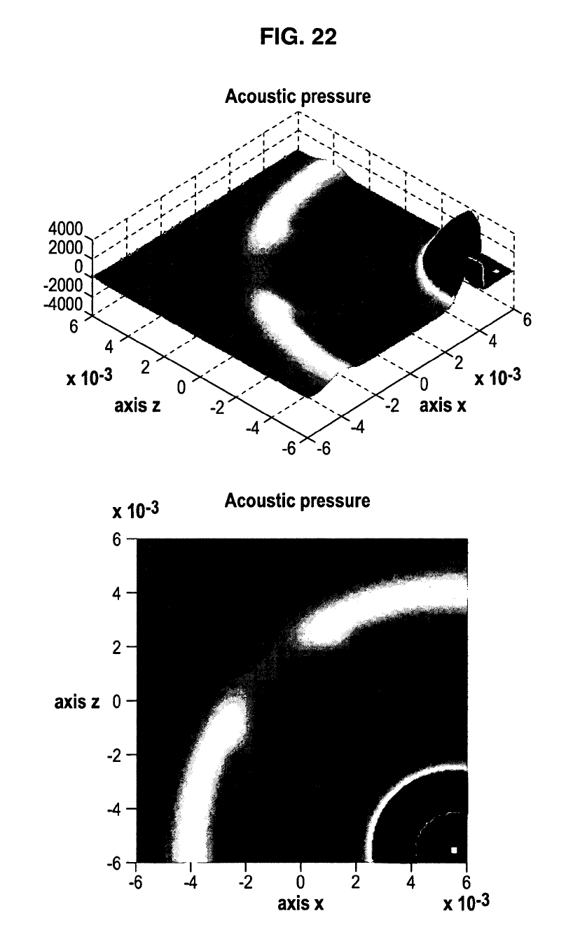

FIG. 22 allows us to observe the wave reflected by the air bubble, which reforms a circle from the point of impact of the wave on its surface. These data obviously take on their full meaning when a parameter like time, for example, is added, which makes it possible to see the waves move and interact with the different objects.

### Conclusion

The semi-analytical modelling method called DPSM rests on a synthesis of the quantities by arrays of point sources placed along the active surfaces (transducers, for example) or on both sides of the interfaces present in a three-dimensional problem. The solution of the initial analytical equations is reduced to the solution of a number of elementary equations equal to the number of point sources. These sources are calculated so as to satisfy the boundary conditions of the problem, without approximation, and the user remains close to the physics of his problem.

The results are therefore obtained in the form of a matrix, which gives a model and not a simulation: this (fast) model is then usable in optimization or in signal processing (inverse problem) phases. The boundary conditions are calculated so as to connect the potential with its (spatial) derivative along the normal to the interface, whether the potential is scalar or vector. The method is therefore applicable to problems involving tensors, such as solid-solid interfaces in ultrasonics, or electromagnetic modelling problems.

It is also possible to vary a temporal and/or geometric parameter, and thus build animations which assist in the interpretation of the original problem structure, which is often complicated.

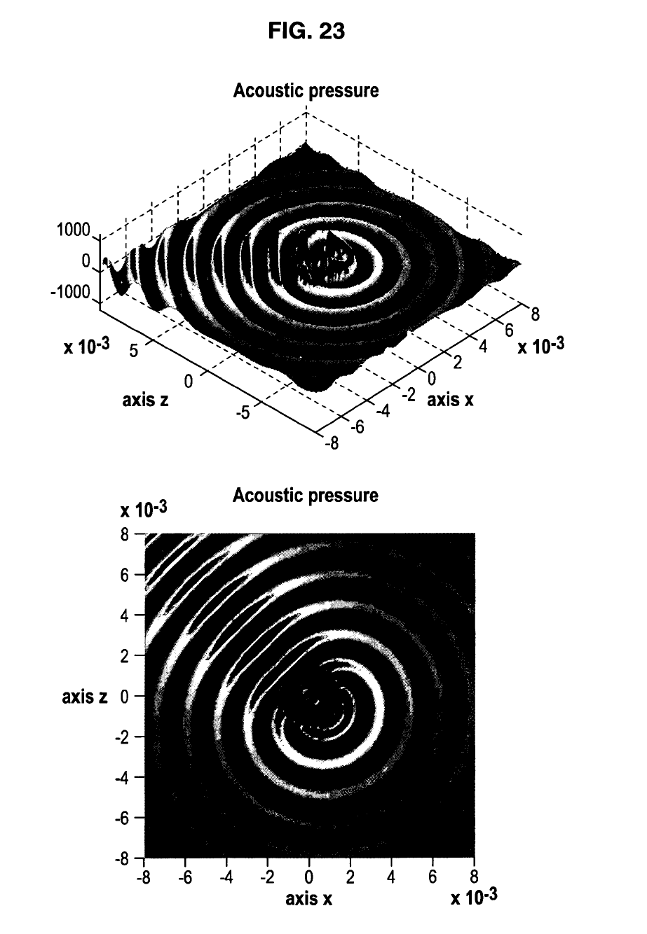

One important aspect of this model is its ability to separate the effects of the different objects in the problem, once it has been solved and the values of all the sources are known. For example, it is possible to display only the quantities radiated by a flaw, and thus determine the best location for placing the sensors. The DPSM method model therefore allows the creation of a virtual instrumentation, its optimization and then, when the measurement instrument is built and measurement signals are available, this model can be employed in quasi-real time in an inverse problem type scheme for the purpose of estimating the properties of the materials under test. One example of this property is illustrated in FIG. 23, which shows only the signals radiated by the air bubble under the conditions described in FIG. 18.

The method according to the invention finds many applications in the field of characterization of media, in particular in the context of non-destructive evaluation (NDE). It allows the solution of inverse problems in impulsive NDE. Applications in the fields of RADAR, of SONAR and of telecommunications are quite possible.

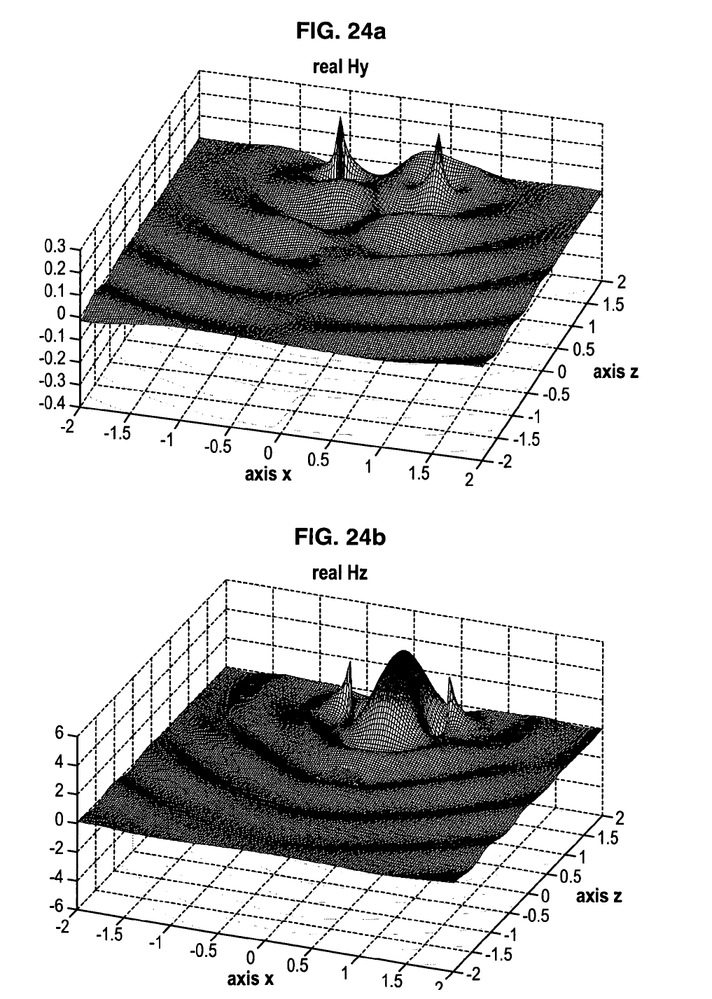

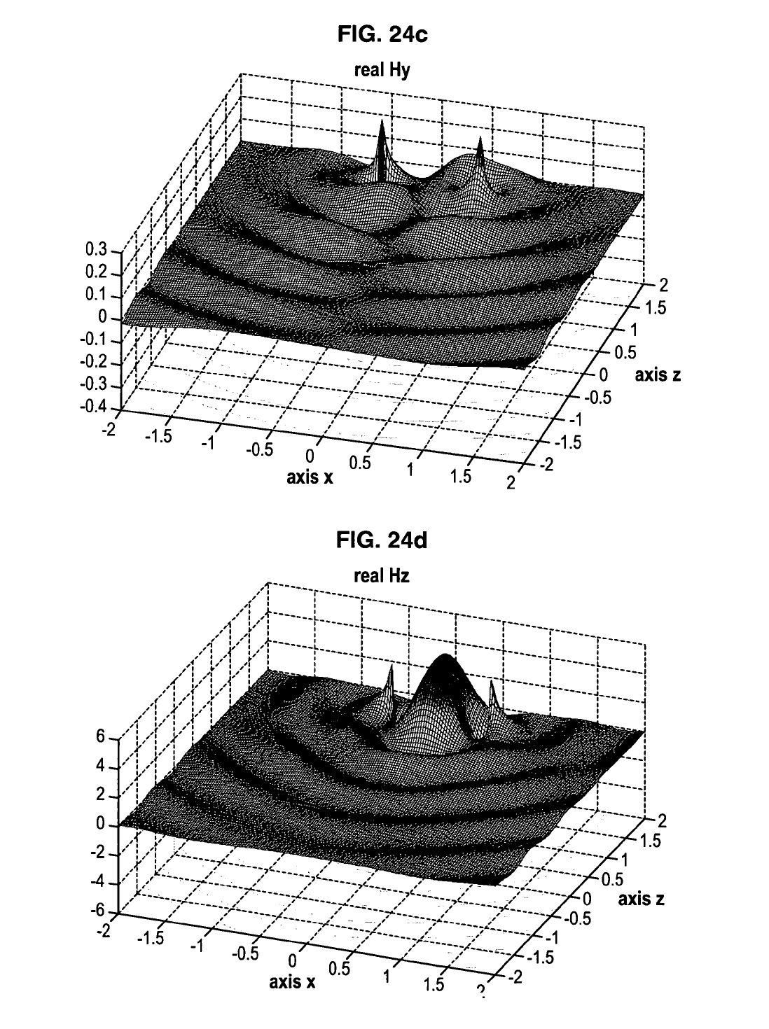

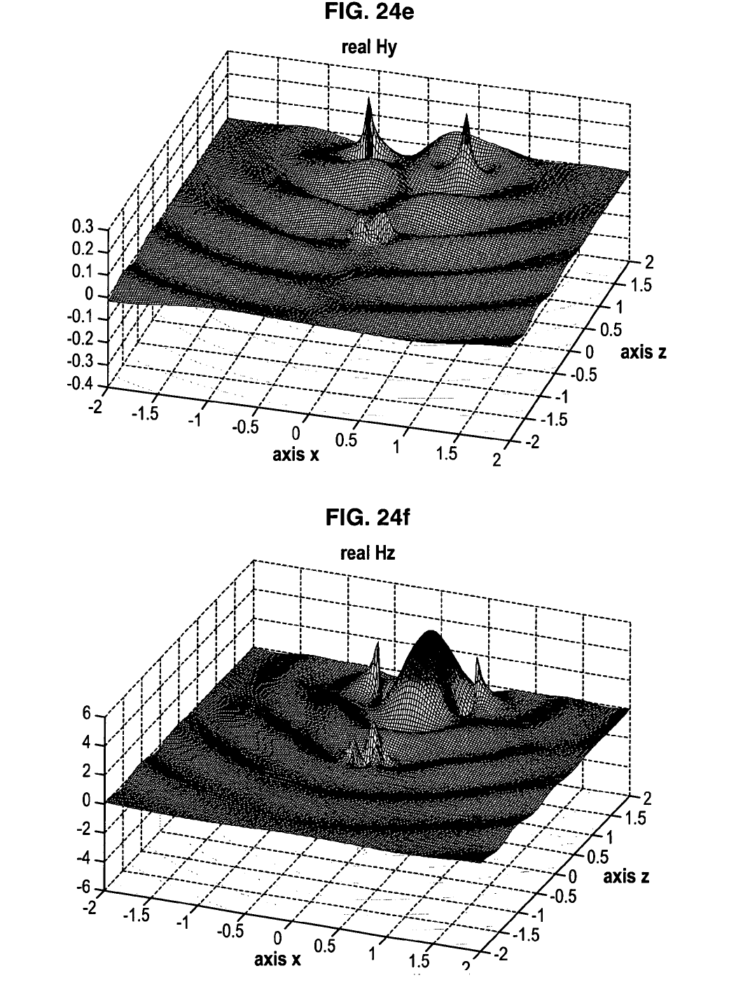

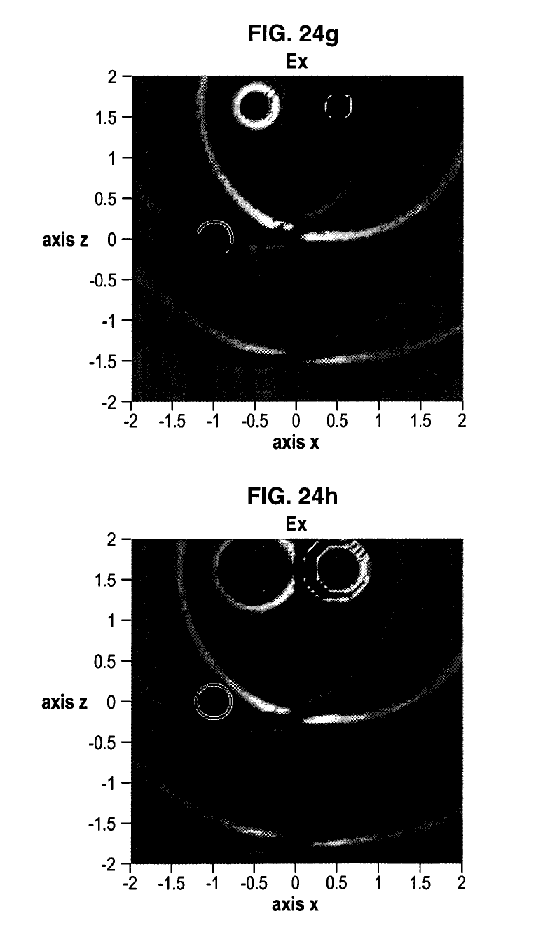

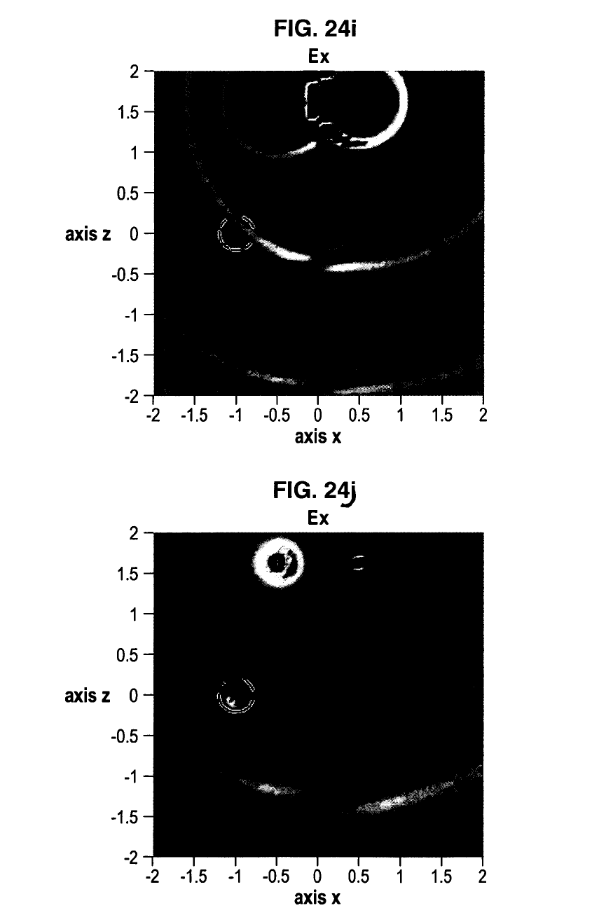

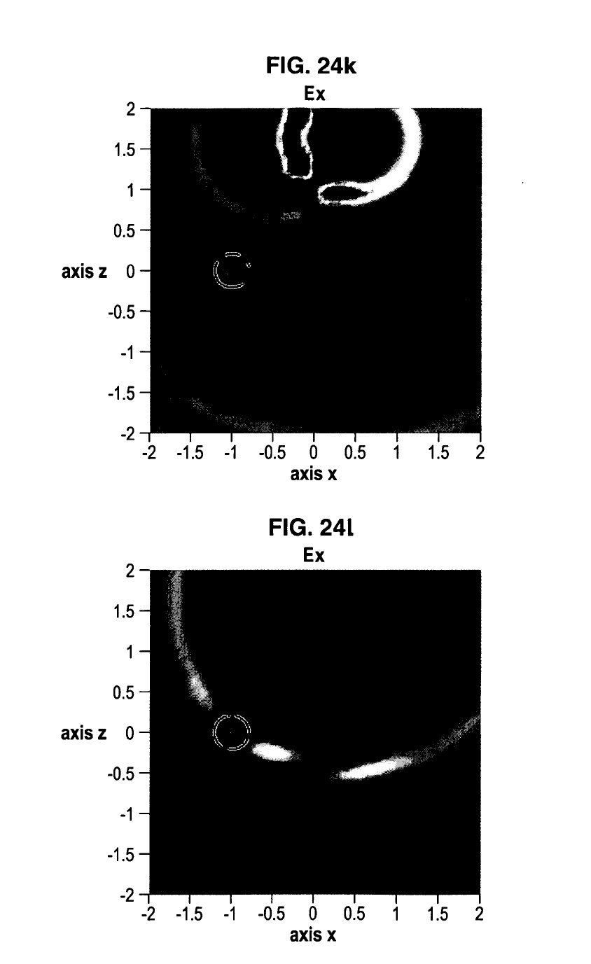

In the field of NDE in particular, that using eddy currents is considered in order to characterize flaws that may be present in an object. Such an application of the method according to the invention is illustrated in FIGS. 24a to 1.

FIGS. 24a through f illustrate a first example where a current-carrying turn, in the XoY plane, faces a volume object (sphere). The electromagnetic field is in isochronous mode and the visualization is in the transverse plane XoZ passing through the centre of the turn and of the sphere. The configuration is f=400 MHz, Rₜᵤᵣₙ=0.50 m, turn centre=[0,0,1.6125], Rₛₚₕₑᵣₑ=0.21 m, sphere centre=[0,0,0], Medium 1=ambient medium and Medium 2=sphere.

FIGS. 24g through l illustrate a second example where a current-carrying turn, in the XoY plane, faces a volume object (sphere). The electromagnetic field is in impulsive mode and the visualization is in the transverse plane XoZ passing through the centre of the turn and of the sphere. The configuration is f=200 MHz, Rₜᵤᵣₙ=0.50 m, turn centre=[0,0,1.6125], Rₛₚₕₑᵣₑ=0.21 m, sphere centre=[−1,0,0] (the turn is offset to the left with respect to the last example), Medium 1=ambient medium and Medium 2=sphere.

We have seen, however, through the foregoing examples, that the method according to the invention is generic and transposable into multi-physics (ultrasonics, acoustics, microwaves, thermal physics, etc.). The field of acoustic microscopy is a field of application of the method according to the invention. The same is true of geophysics.

What is more, the method according to the invention differs from the techniques currently in use for assessing flaws in structures in that:
it is usable in real-time processes (for example during data acquisition),
it is flexible enough to be used for complex media to solve the direct (modelling) or inverse (media characterization from experimental data) problem.

The method according to the invention therefore solves the problems connected with the lack of robustness, the difficulties in implementation and the lack of generalization of the techniques currently in use. It is also free of the prohibitive calculation time and of the necessity of a priori knowledge which make the more elaborate current methods difficult to implement in an industrial setting. One of the advantages of the method according to the invention is connected with its performance (speed and capacity for generalization) as well as its simplicity of implementation. As a result, the method according to the invention is easily usable in an industrial setting.

Naturally, it is possible to make many modifications to the invention without departing from the substance of it.

1. A method for modelling the interactions of a wave, generated by a source emitting an impulsive signal of arbitrary shape, with a medium, including steps consisting of:
a) elaboration of a generic model by the method called “DPSM”;
b) Fourier series decomposition of the impulsive signal;
c) for each of the harmonics arising from the foregoing decomposition, calculation of a model specifically for the harmonic in question from the generic model previously elaborated; and
d) superposition of a set of specific models thus calculated in order to assemble a final model.

2. A method according to claim 1, characterised in that, for step c), the harmonics selected are those located under the first lobe of the spectrum envelope of the impulsive signal.

3. A method according to claim 2, characterised in that the harmonics selected are the first nine.

4. A method according to one of claims 1 through 3, characterised in that, for step d), each specific model is assigned a superposition coefficient.

5. A method according to one of claims 1 through 4, characterised in that the impulsive signal is an acoustic, ultrasonic, electromagnetic, electrical, magnetic, thermal, photothermal, or microwave signal.
